(19) United States
(12) Patent Application Publication
(10) Pub. No.: US 2007/0050760 A1
(43) Pub. Date: Mar. 1, 2007

(54) GENERATION OF APPLICATION SPECIFIC XML PARSERS USING JAR FILES WITH PACKAGE PATHS THAT MATCH THE XML XPATHS

(76) Inventors: ERXIANG LIU, Austin, TX (US); James M. McArdle, Austin, TX (US); Ningning Wang, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/382,280

(22) Filed: May 9, 2006

Related U.S. Application Data
(63) Continuation-in-part of application No. 11/214,566, filed on Aug. 30, 2005.

(51) Int. Cl. G06F 9/45; G06F 17/00

(52) U.S. Cl. 717/143; 715/513; 717/144

(57) ABSTRACT

A method of XML parsing is provided. In an exemplary embodiment, the method may include: parsing of an XML document; constructing an XML XPATH which includes at least one XML XPATH tag; constructing a JAR file of Java classes which include at least one package path that matches the at least one XML XPATH tag; accessing the JAR file of Java classes which include the at least one package path that matches the at least one XML XPATH tag; and transferring the at least one XML XPATH tag to the JAR file of Java classes including the at least one package path that matches the at least one XML XPATH tag for processing.

### CROSS-REFERENCE TO RELATED APPLICATIONS

The present application is a continuation-in-part under 35 U.S.C. §120 of U.S. application Ser. No. 11/214,566, entitled “XML COMPILER THAT WILL GENERATE AN APPLICATION SPECIFIC XML PARSER,” filed on Aug. 30, 2005. The present application is related to the following co-pending United States Patent Applications: United States Patent Application entitled “METHOD OF XML TRANSFORMATION AND PRESENTATION UTILIZING AN APPLICATION SPECIFIC PARSER,” Docket No. AUS920050753US1; United States Patent Application entitled “ENABLEMENT OF MULTIPLE SCHEMA MANAGEMENT AND VERSIONING FOR APPLICATION SPECIFIC XML PARSERS,” Docket No. AUS920050754US1; and United States Patent Application entitled “METHOD OF XML ELEMENT LEVEL COMPARISON AND ASSERTION UTILIZING AN APPLICATION SPECIFIC PARSER,” Docket No. AUS920050757US1. All of the aforementioned applications are hereby incorporated by reference in their entireties.

### FIELD OF INVENTION

The present invention generally relates to the field of software, and more particularly to a method of application-specific processing of XML files.

### BACKGROUND OF THE INVENTION

Extensible Markup Language (XML) is a widely accepted standard for describing data. XML is a standard that allows an author/programmer and the like to describe and define data (e.g., type and structure) as part of the XML content/document. XML uses syntax tags to identify various types of data in a file. Since XML content may describe data, any application that understands XML regardless of the applications programming language and platform has the ability to process the XML based content.

An XML parser is a software program that reads XML files and makes the information from those files available to applications and programming languages, usually through a known interface. The XML content may optionally reference another document or set of rules that define the structure of an XML document/content. This other document or set of rules is often referred to as a schema. When an XML document references a schema, some parsers may check for validity in which the parser determines if the document follows the rules schema.

The Extensible Markup Language (XML) has become the industry standard for exchanging data across systems because of the language's flexibility and consistent syntax. However, conventional XML parsing (e.g., parsing by use of a general-purpose external parser) is slow in many applications. General-purpose parsers process XML content into general-purpose data structures, then apply run-time analysis to rebind the data to application-specific structures. Extra space is consumed by intermediate data structures (e.g., general purpose data structures) and extra time may be spent creating and analyzing them. Moreover, it is labor intensive to write the conversion code that converts the general-purpose data structures to application-specific data structures required for final processing.

There are three broad types of conventional XML parsers: SAX (Simple API for XML) parsers, DOM (Document Object Model) parsers, and data-binding parsers. Typical commercially available parsers use DOM parsers and SAX parsers together. Each type of XML parser defines a standard for accessing and manipulating XML documents. However, each of these parsers.

A SAX parser uses an event-driven model to process XML content. A SAX parser initiates a series of events as it reads an XML document from beginning to end. The events are passed to event handlers, which provide access to the content in the document. Some of these event handlers check the syntax of the XML document (e.g., syntactic events). In conventional SAX parsers, a developer has to program the event handlers (e.g., developer-written events). In addition, a SAX parser invokes developer-written callback routines to manage the syntactic events. A callback routine is a routine that is executed as part of the operation of some other routine. A limitation of the SAX parser is the requirement for manual programming of the event handlers and callback routines. Further, the conventional SAX parser perform a number of routines such as scanning the XML input multiple times, creating a number of intermediate data structures and the like while facilitating the parsing of the XML document require a great deal of time to perform.

In contrast to a SAX parser, a DOM parser first parses an XML document to build an internal, tree-shaped representation of the XML document. An application programmer interface (API) is then employed to access the contents of the document tree for further analysis. Such configuration results in slow parsing because the state information that is required for analysis was available at parse time resulting in a redundancy. In addition, DOM parsers typically limit parallel processing by building the tree before invoking analysis code.

In addition, a data-binding parser operates by mapping XML elements to element-specific objects. Such parsers are limited for data-binding engines often use high-cost methods such as reflection and run-time rule evaluation.

Therefore, it would be desirable to provide a method and an apparatus for performing XML parsing which is cost-effective and not as labor intensive as conventional parsers.

### SUMMARY OF THE INVENTION

In a first aspect of the present invention, a method of XML parsing is provided. In an exemplary embodiment, the method may include: parsing an XML document; constructing an XML XPATH which includes at least one XML XPATH tag; constructing a JAR file of Java classes which include at least one package path that matches the at least one XML XPATH tag; accessing the JAR file of Java classes which include the at least one package path that matches the at least one XML XPATH tag; and transferring the at least one XML XPATH tag to the JAR file of Java classes including the at least one package path that matches the at least one XML XPATH tag for processing.

In a further aspect of the present invention, a computer program product, including a computer useable medium with computer usable program code for creating a method for XML parsing is provided. The computer program product may include: computer usable program code for parsing an XML document; computer usable program code for constructing an XML XPATH with at least one XML XPATH tag; computer usable program code for constructing a JAR file of Java classes which include at least one package path that matches the at least one XML XPATH tag; computer usable program code for accessing the JAR file of Java classes which include the at least one package path that matches the at least one XML XPATH tag; and computer usable program code for transferring the at least one XML XPATH tag to the JAR file of Java classes including the at least one package path that matches the at least one XML XPATH tag for processing.

In an additional aspect of the present invention, a method of parsing an XML document is provided. The method may include constructing an interface for at least one XML tag. The method may also include creating a Java class to process the at least one XML tag. For example, the Java class includes code to evaluate at least one attribute of the at least one XML tag. In addition, the method may include parsing of the XML document by processing the at least one attribute of the at least one XML tag.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of XML parsing in accordance with an exemplary embodiment of the present invention;

FIG. 2 is a flow diagram illustrating an additional method of XML parsing in accordance with an exemplary embodiment of the present invention; and

FIG. 3 is exemplary code for the method of XML parsing illustrated in FIG. 2.

### DETAILED DESCRIPTION OF THE INVENTION

Reference will now be made in detail to the presently preferred embodiments of the invention, examples of which are illustrated in the accompanying drawings.

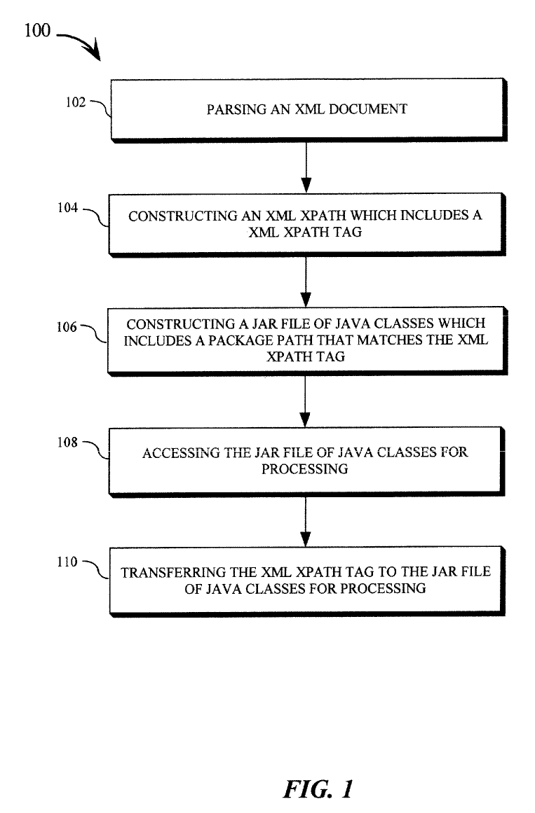

Referring to FIG. 1, a method 100 of XML parsing is provided. In an exemplary embodiment, the method 100 may include parsing of an XML document 102. For example, the parsing of the XML document 102 is performed by a SAX parser. In addition, the method 100 may include constructing an XML XPATH which includes at least one XML XPATH tag 104. In an embodiment, the constructing of an XML XPATH may be performed by a general purpose parser such as a SAX parser. XPATH (abbreviation for XML path language) is a language which is primarily used to address parts of an XML document and find information in such document. For example, XPATH is used to navigate through elements and attributes in an XML document. In addition, XPATH provides basic facilities for manipulation of strings, numbers and Booleans. XPATH is designed to be used with XSLT (acronym for Extensible Style Language Transformation) and X pointer. Further, XPATH treats an XML document as a logically ordered tree.

In further exemplary embodiments, the method 100 of XML parsing includes constructing a JAR (abbreviation for Java Archive) file of Java classes which include at least one package path that matches the at least one XML XPATH tag 106. A JAR file may be a file used to distribute a set of Java classes or to store compiled Java classes and associated metadata that may constitute a program. In an embodiment, the at least one XML XPATH tag includes a tag attribute XML document file descriptor.

The method 100 may include accessing the JAR file of Java classes which include the at least one package path that matches the at least one XML XPATH tag 108. For example, accessing the JAR file of Java classes 108 is performed by a SAX parser. In such example, the SAX parser accesses the JAR file of Java classes by a class loader.

In addition, the method 100 includes transferring the at least one XML XPATH tag to the JAR file of Java classes including the at least one package path that matches the at least one XML XPATH tag for processing 110. For example, transferring the at least one XML path tag to the JAR file of Java classes includes transferring the tag attribute XML document file descriptor.

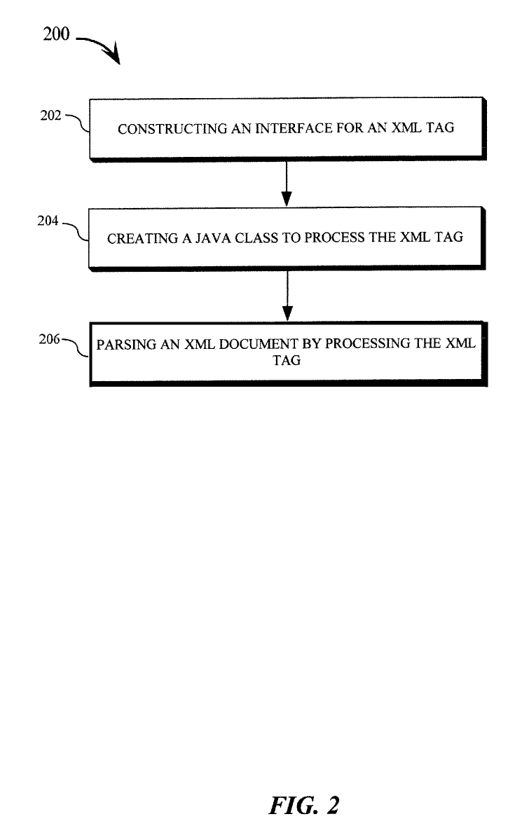

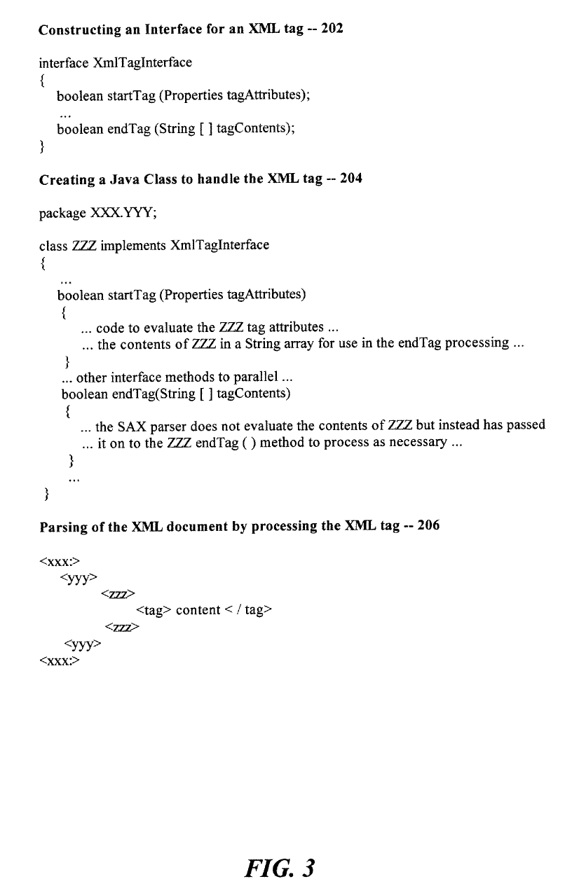

Referring to FIG. 2, a method 200 of parsing an XML document is provided. The method 200 may include constructing an interface for at least one XML tag 202. As illustrated in FIG. 3, the interface may be constructed by using Boolean logic. In further embodiments, the interface may be constructed by use of a general purpose parser such as a SAX parser.

The method 200 may also include creating a Java class to process the at least one XML tag 204. For example, as illustrated in FIG. 3, the Java class includes code to evaluate at least one attribute of the at least one XML tag. In an embodiment, the Java class includes Boolean code to evaluate the at least one XML tag. For instance, the Boolean code may do the set-up work for an endTag( ) method and returning of a FALSE indicator may cause a parser to parse and record the tag. It is contemplated that a general purpose parser such as a SAX parser may be employed to write Java classes to handle various XML tags.

In addition, the method 200 may include parsing of the XML document by processing the at least one attribute of the at least one XML tag 206. In an embodiment, parsing of the XML document by processing the at least one attribute of the at least one XML tag 206 is performed by a SAX parser. For instance, the exemplary XML document provided in FIG. 3 may be processed by scanning for zzz.yyy.xxx.tag.class, zzz.yyy.tag.class, and zzz.tag.class. In the present example, zzz is allowed to have a different behavior in the three classes based on the context of zzz within xxx and yyy or only within yyy. In such example, the last scan is for zzz having the same behavior regardless of where it is embedded. Such configuration removes the need to employ a second XML document to describe the actions to be performed for a given tag is encoded within the JAR file.

It is to be understood that the present invention may be implemented by using compiler technology to automatically generate a fast and small application specific parser. In such embodiment, an XML input file and two or more specifications are provided. Each specification may include two components: (1) an XML schema that specifies syntax, data elements, and data types and (2) semantic actions that include a pairing of an XPath string and an action code. The specifications and the XML input file are used to generate a state machine and state transition sequences that invoke the semantic actions. The state transition sequences are then used to generate the application-specific XML parser.

An exemplary method of generating an XML parser may include receiving an XML input file and specifications each comprising an application specific XML schema and semantic action, where the XML input file is compliant with the XML schema and the semantic action. In an embodiment, the input is in a format of JAR file. The method may also include generating a state machine in response to the specifications and generating state transition sequences in response to specifications and in response to the state machine. An application-specific parser may then be generated in response to the state transition sequences.

It is to be understood that the disclosed invention may be employed in a number of systems including embedded systems such as a Service Management Framework (SMF). Further, the present invention may be utilized by consulting services such as WebSphere Commerce (WCS) and WebSphere Business Integration (WBI). In addition, the invention may be used in performance critical applications such as SMF and web services. It is to be further understood that although the present disclosure presents exemplary embodiments involving Java programming language, any programming language with similar packaging mechanism as Java may be employed.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk -read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become couple to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of Extensible Markup Language (XML) parsing, comprising steps of:
parsing of an XML document;
constructing an XML path language (XPATH), the XPATH including at least one XML XPATH tag;
constructing a Java Archive (JAR) file of Java classes, the Java classes including at least one package path that matches the at least one XML XPATH tag;
accessing the JAR file of Java classes; and
transferring the at least one XML XPATH tag to the JAR file of Java classes including the at least one package path that matches the at least one XML XPATH tag for processing.

2. The method as claimed in claim 1, wherein the step of parsing the XML document is performed by a Simple API for XML (SAX) parser.

3. The method as claimed in claim 1, wherein the step of constructing the XPATH is performed by a Simple API for XML (SAX) parser.

4. The method as claimed in claim 1, wherein the step of accessing the JAR file of Java classes is performed by a Simple API for XML (SAX) parser.

5. The method as claimed in claim 4, wherein the SAX parser accesses the JAR file of Java classes by a class loader.

6. The method as claimed in claim 1, wherein the at least one XML XPATH tag includes a tag attribute XML document file descriptor.

7. The method as claimed in claim 6, wherein the step of transferring the at least one XML path tag to the JAR file of Java classes includes transferring the tag attribute XML document file descriptor.

8. A computer program product, comprising:
a computer useable medium including computer usable program code for creating a method for Extensible Markup Language (XML) parsing, the computer program product including:
computer usable program code for parsing an XML document;
computer usable program code for constructing an XML path language (XPATH), the XPATH including at least one XML XPATH tag;
computer usable program code for constructing a Java Archive (JAR) file of Java classes, the Java classes including at least one package path that matches the at least one XML XPATH tag;
computer usable program code for accessing the JAR file of Java classes; and
computer usable program code for transferring the at least one XML XPATH tag to the JAR file of Java classes including the at least one package path that matches the at least one XML XPATH tag for processing.

9. The computer program product as claimed in claim 8, wherein computer usable program code for parsing of the XML document is performed by a Simple API for XML (SAX) parser.

10. The computer program product as claimed in claim 8, wherein computer usable code for constructing the XML XPATH is performed by a Simple API for XML (SAX) parser.

11. The computer program product as claimed in claim 8, wherein computer usable code for accessing the JAR file of Java classes is performed by a Simple API for XML (SAX) parser.

12. The computer program product as claimed in claim 11, wherein the SAX parser accesses the JAR file of Java classes by a class loader.

13. The computer program product as claimed in claim 8, wherein the at least one XML XPATH tag includes a tag attribute XML document file descriptor.

14. The computer program product as claimed in claim 13, wherein the computer usable code for transferring the at least one XML path tag to the JAR file of Java classes includes transferring the tag attribute XML document file descriptor.

15. A method of parsing an Extensible Markup Language (XML) document, comprising the steps of:
constructing an interface for at least one XML tag;
creating a Java class to process the at least one XML tag, the Java class including code to evaluate at least one attribute of the at least one XML tag; and
parsing the XML document by processing the at least one attribute of the at least one XML tag.

16. The method as claimed in claim 15, wherein the step of parsing the XML document by processing the at least one attribute of the at least one XML tag is performed by a Simple API for XML (SAX) parser.

17. The method as claimed in claim 15, wherein the step of constructing the interface for at least one XML tag is performed by using Boolean logic.

18. The method as claimed in claim 15, wherein the step of creating the Java class to process the at least one XML tag is performed by using Boolean logic.

19. The method as claimed in claim 15, wherein the constructing the interface for the at least one XML tag is performed by a Simple API for XML (SAX) parser.

20. The method as claimed in claim 15, wherein the step of creating the Java class to process the at least one XML tag is performed by a Simple API for XML (SAX) parser.
